(19) United States
(12) Patent Application Publication
(10) Pub. No.: US 2003/0160408 A1
(43) Pub. Date: Aug. 28, 2003

(54) Collapsing device for a golf cart

(76) Inventor: Gordon Liao, Yung Kang City (TW)

Correspondence Address: BACON & THOMAS, 625 SLATERS LANE, 4TH FLOOR, ALEXANDRIA, VA, 22314-1176, US

(21) Appl. No.: 09/774,746

(22) Filed: Jan. 30, 2001

(51) Int. Cl. B62B 1/12; B62B 1/00

(52) U.S. Cl. 280/47.24

(57) ABSTRACT

A collapsing device for a golf cart includes an upper rod provided with a lengthening unit, a lower unit connected to a lower rend of the upper rod, and a collapsing unit provided between the upper end of the lower rod and the upper rod. Further, a folding unit is provided on the upper portion of the upper rod, permitting the golf cart collapsible to a size as small as possible in cooperation of the lengthening unit and the collapsing unit to lower cost for package and transporting.

### BACKGROUND OF THE INVENTION

This invention relates to a collapsing device for a golf cart, particularly to one reducing dimensions of the golf cart after collapsed to a minimum in order to lessen cost for packaging and transporting.

A known conventional collapsible golf cart shown in FIG. 1 includes an upper rod 1, a lower rod 2 and a collapsing unit 3 connecting the upper rod 1 and the lower rod 2 for collapsing them. Some conventional golf carts have the upper rod 1 provided with a lengthening unit, and others have a folding unit 4 as shown in FIG. 1., and the lower rod 2 bends a little forward, with two wheels collapsibly connected to the lower rod 2.

In case of collapsing the conventional golf cart, the collapsing unit 3 is operated to let the upper rod 1 bending down on the lower rod 2, collapsed in small dimensions shown in FIG. 2. When it is to be packaged, the wheels 5 are collapsed from the lower rod 2, and placed in a case as shown in FIGS. 3 and 4, which has a small size as 249.8 mm×249.8 mm×638.33 mm.

Although this size of the conventional golf cart collapsed is quite smaller than other common conventional golf carts, dimensions of a package case containing a collapsed conventional golf cart largely affect cost for transporting. Especially for makers engaging in manufacture of golf carts for export have to make every effort to work out a collapsible golf cart having a size as small as possible to lower cost for transporting to win competition.

### SUMMARY OF THE INVENTION

The objective of the invention is to offer a collapsing device for a golf cart, which has a size as smallest as possible, to lower largely cost for package and transporting to enhance competitive capacity in market.

### BRIEF DESCRIPTION OF DRAWINGS

This invention will be better understood by referring to the accompanying drawings, wherein:

FIG. 1 is a perspective view of a known conventional golf cart:

FIG. 2 is a side view of the known conventional golf cart in the collapsed condition:

FIG. 3 is an upper view of an open package case contained the collapsed known conventional golf cart:

FIG. 4 is an upper side view of the package case of the collapsed known conventional golf cart in FIG. 3.

FIG. 5 is a perspective view of a golf cart provided with a collapsed device in the present invention:

FIG. 6 is a perspective view of the golf cart being collapsed to a first step in the present invention:

FIG. 7 is a perspective view of the golf cart being collapsed to a second step in the present invention:

FIG. 8 is a perspective view of the golf cart being collapsed to a third step in the present invention:

FIG. 9 is a perspective view of the golf cart being collapsed to a last forth step in the present invention:

FIG. 10 is a side view of the golf cart completely collapsed in the present invention:

FIG. 11 is an upper view of an open package case for placing the collapsed golf cart in the present invention:

FIG. 12 is an upper view of FIG. 11:

FIG. 13 is an exploded perspective view of a folding unit provided on an upper rod in the present invention:

FIG. 14 is a side view of the folding unit provided on the upper rod being handled for a first step in the present invention:

FIG. 15 is a side view of the folding unit provided on the upper rod being handled for a second step in the present invention:

FIG. 16 is an exploded perspective view of a scoreboard in the present invention:

FIG. 17 is a cross-sectional view of the scoreboard being adjusted in its angle with a first step in the present invention: and,

FIG. 18 is a cross-sectional view of the scoreboard being adjusted in its angle with a second step.

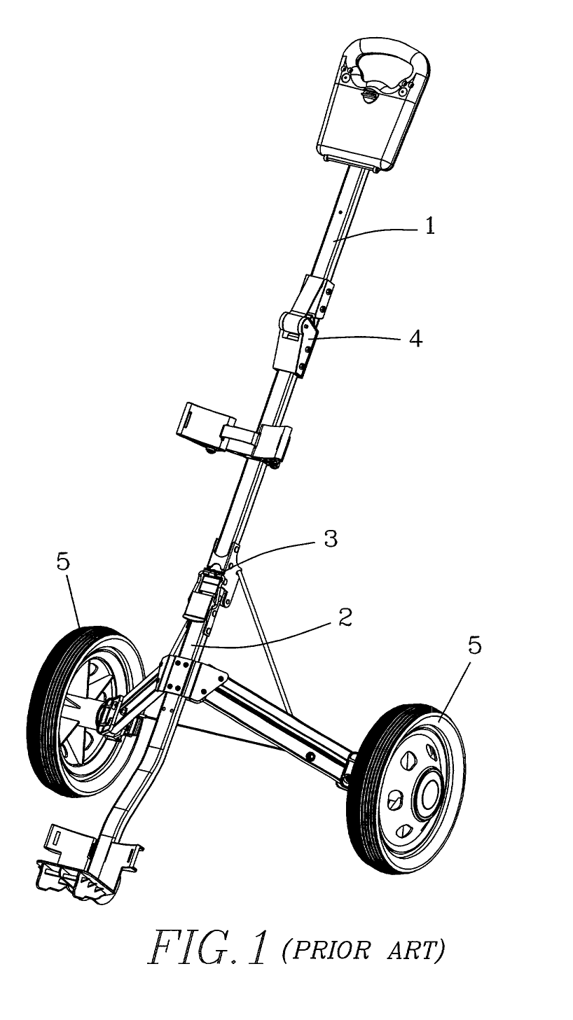

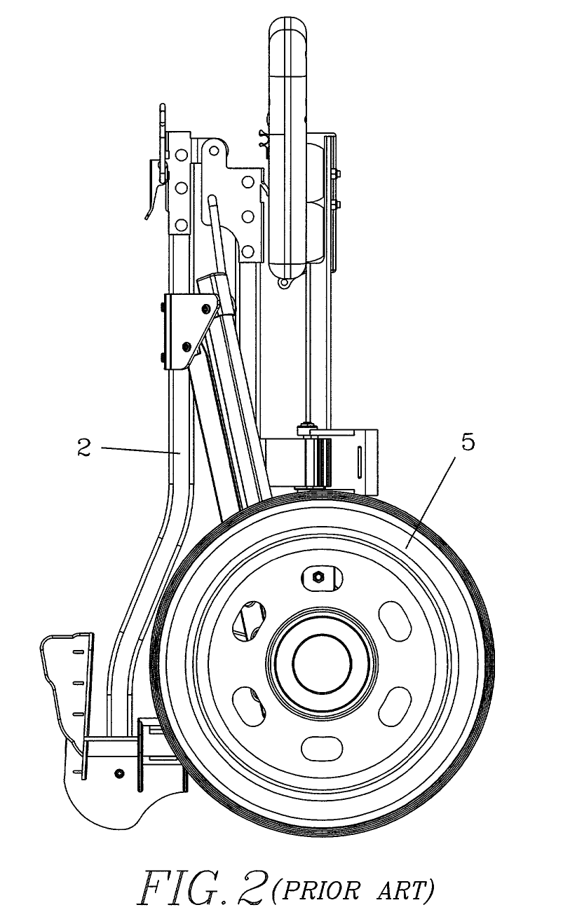

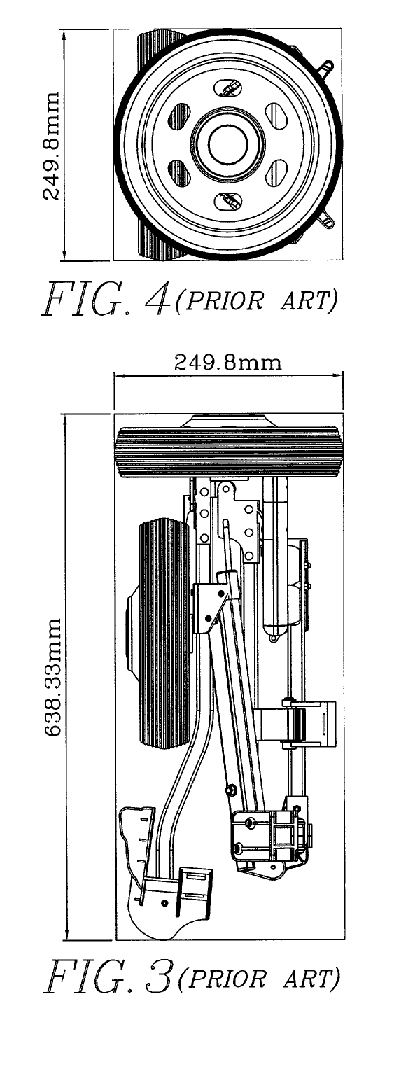

### DETAILED DESCRIPTION OF THE PREFERRED EMBODIMENT

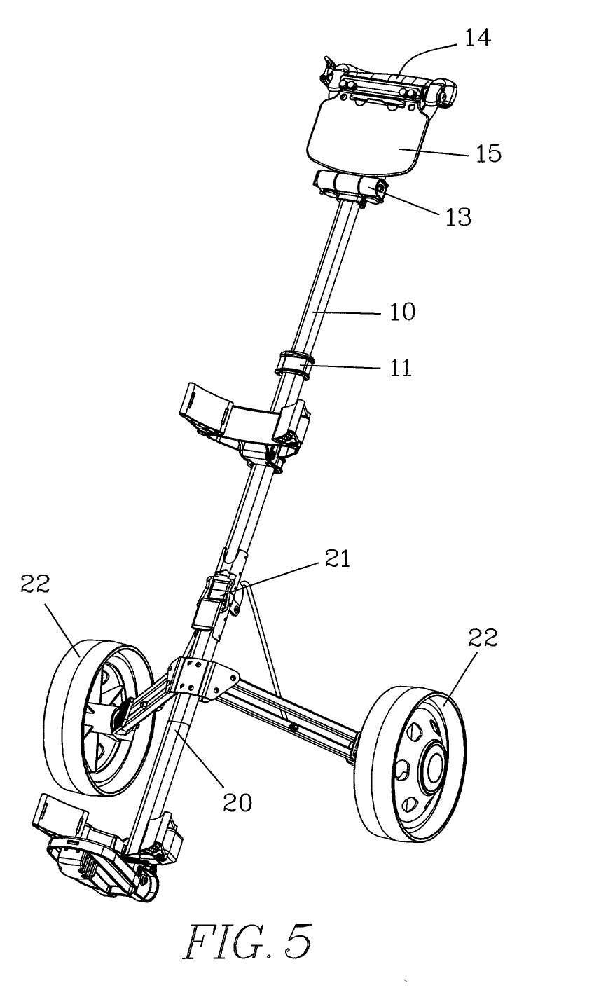

A preferred embodiment of a collapsing device for a golf cart in the present invention, as shown in FIG. 5, includes an upper rod 10, a lengthening unit 11, a folding unit 13, a lower rod 20, and an engaging unit 21 as main components combined together.

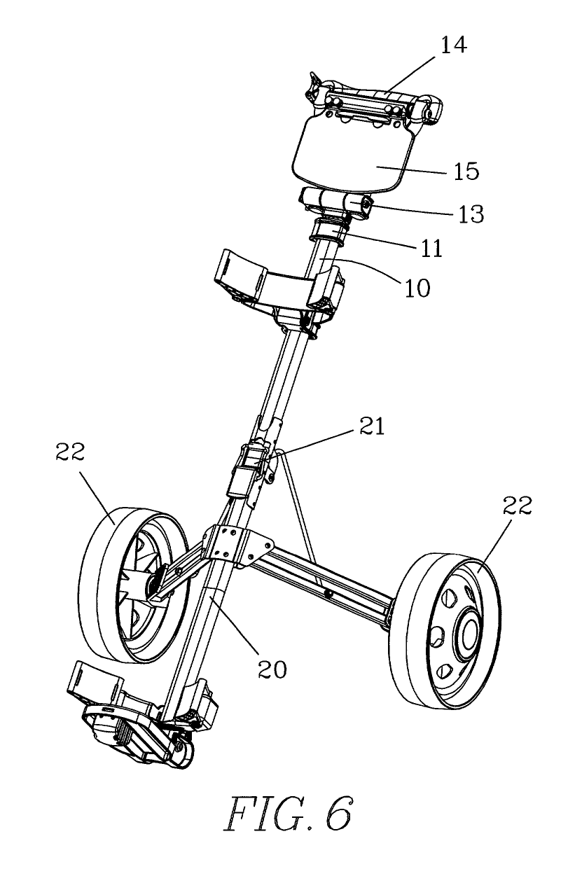

The lengthening unit 11 is combined on the upper rod 10 for lengthening or shortening the upper rod 1 relative to the lower rod 20, as shown in FIG. 6. The folding unit 13 is fixed on an upper portion of the upper rod 1 above the lengthening unit 11, and a handle 14 is fixed on the folding unit 13, with a scoreboard 15 fixed downward with the handle 14.

The lower rod 20 is connected to a lower end of the upper rod 1, and the engaging unit 21 is provided between an upper end of the lower end 20 and the lower end of the upper rod 10. Two wheels 22 are collapsibly combined with the lower rod 20 at two sides. The lower end of the lower rod 1 is shaped as a straight rod.

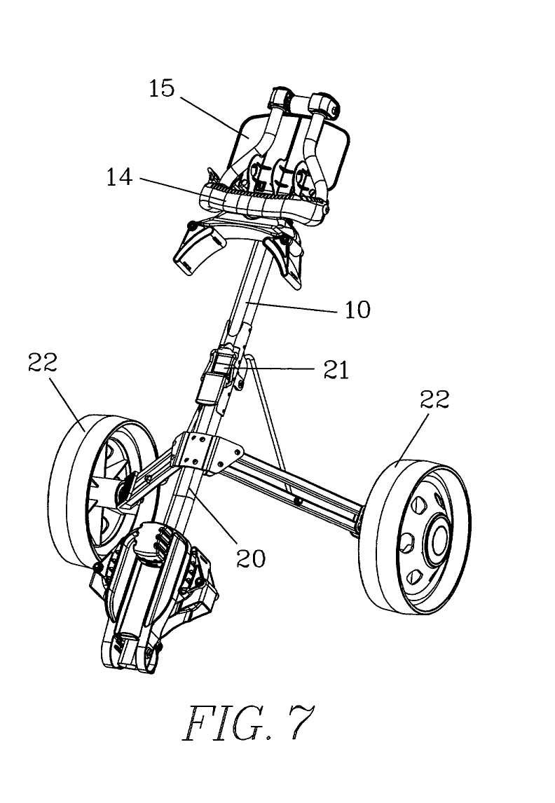

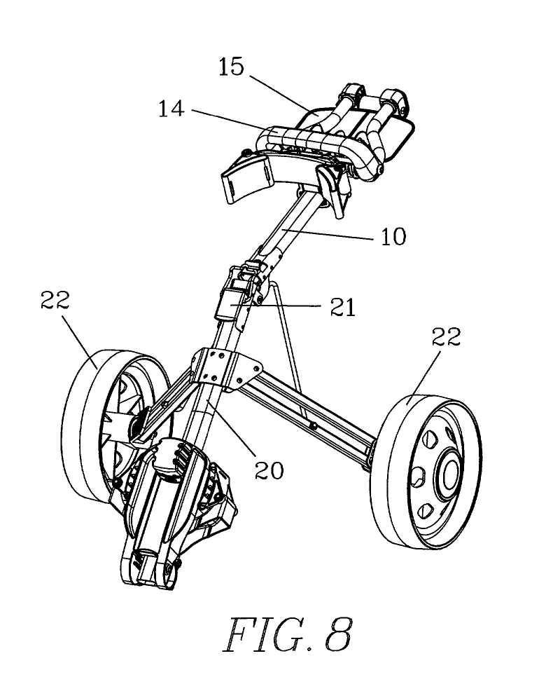

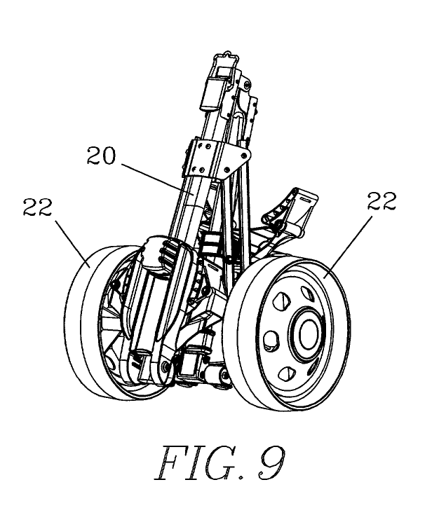

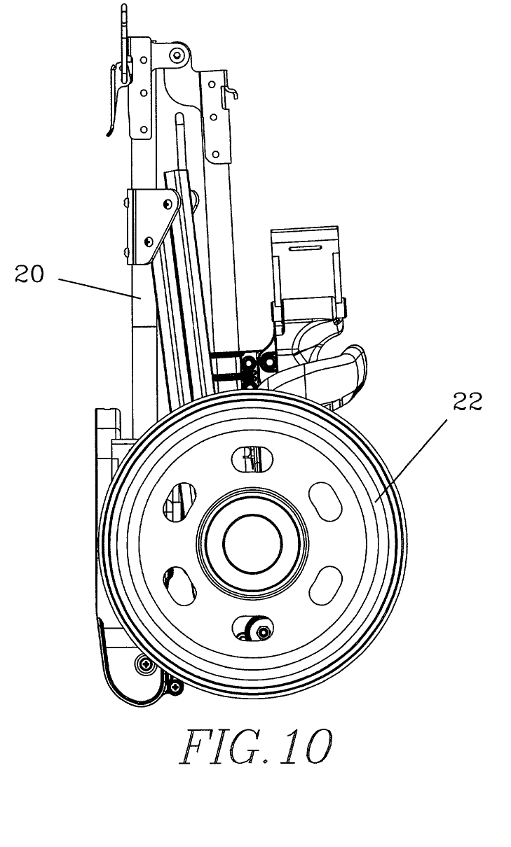

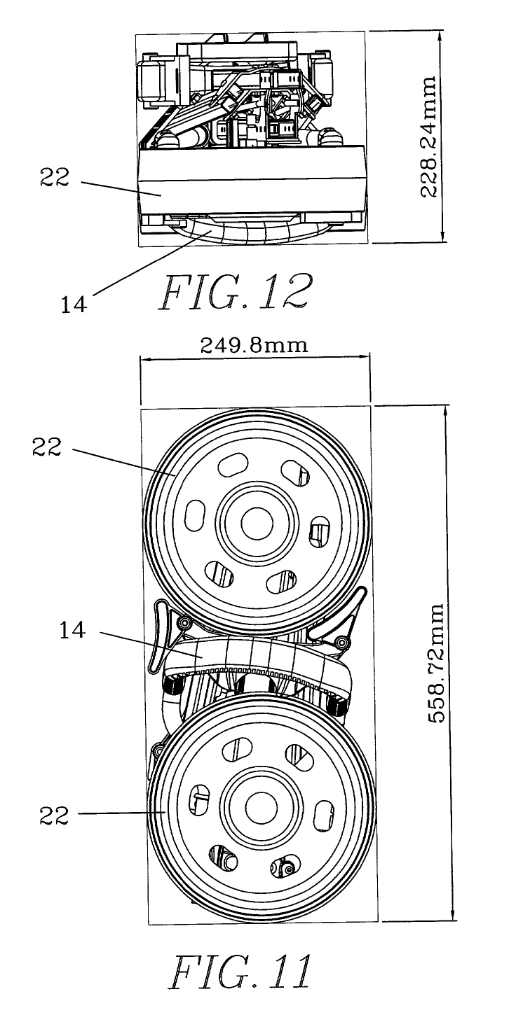

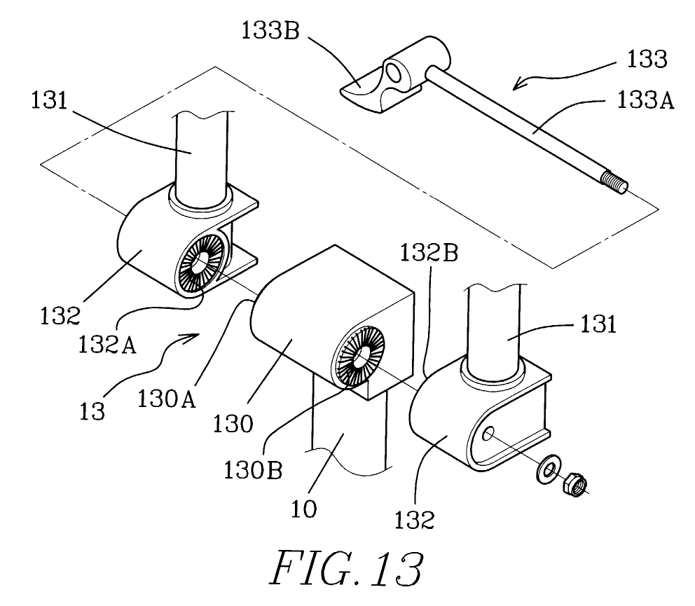

When the golf cart with the collapsing device is to be collapsed, the upper rod 10 may be pushed down with the lengthening device 11 to slide down along the lower rod 20 shortening the whole length of the upper rod 10 and the lower rod 20, as shown in FIG. 6. Then fold down the folding unit 13 of the upper rod 10 as shown in FIG. 7. Next, disengage the engaging unit 21 located between the upper rod and the lower rod 20 as shown in FIG. 8, becoming the condition shown in FIGS. 9 and 10, that is, a completely collapsed condition.

If the collapsed golf cart is to be placed in a package case, the two wheels 22 are to be collapsed down, and the package case can be made as small as the size of 249.8 mm×228.24 mm×555.72 mm. Obviously, this size is smaller than that of the package case for the known conventional golf cart collapsed as mentioned above, effectively lowering cost for package and transporting for makers, who can enhance competing ability in market.

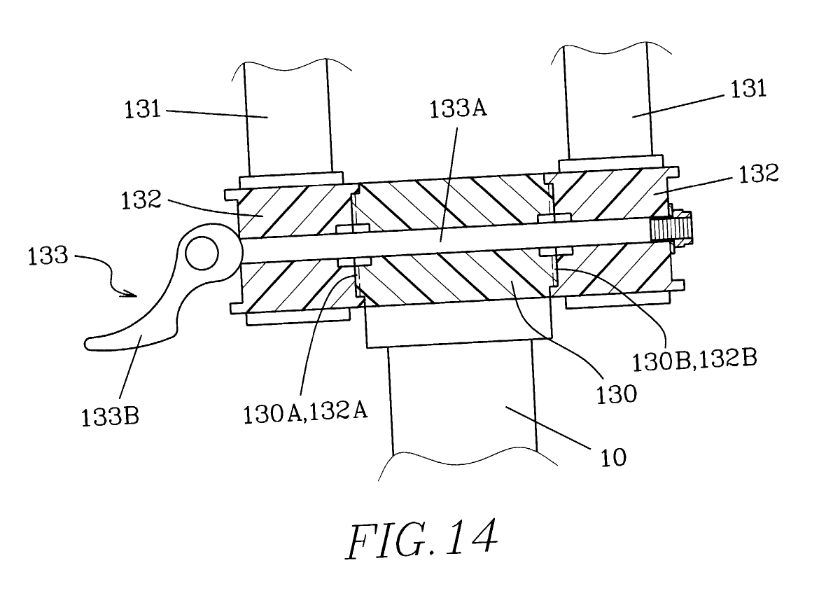

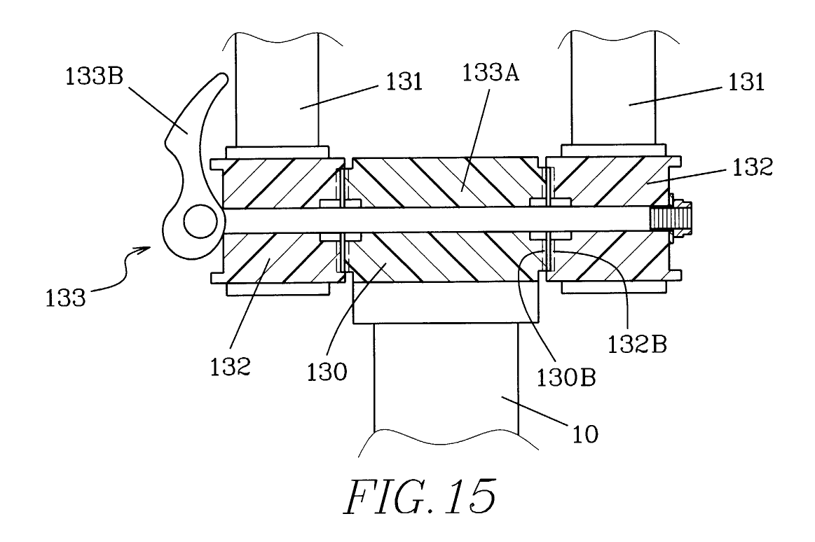

Further, the folding unit 13 on the upper rod 10 includes a fix protruding base 130 fixed firmly on the upper rod 10, a link rod 132 respectively combined with two lengthwise sides of the fix protruding base 130, and a position element 133 having a elongate rod 133A and an eccentric push block 133B fixed with an end of t h e elongate rod 133A, which extends through the fix protruding base 130 and the two link bases 132 for adjusting tightness between the fix protruding base 130 and the link base 132. The fix protruding base 130 further has a first flat toothed disc 130A and a second flat toothed disc 130B on the two lengthwise opposite sides, and the two link bases respectively have a third toothed disc 132A respectively engaging or disengaging from the two flat toothed discs 130A so that the folding unit 13 may be folded or straightened, as shown in FIGS. 14 and 15. Aside from folding and straightening function, the folding unit 13 can also function to adjust its angle, thus capable to adjust the angle of the handle 14. Therefore, a user of the golf cart in the invention can adjust the angle between the handle 14 and the upper rod 10 to suit to his/her body height.

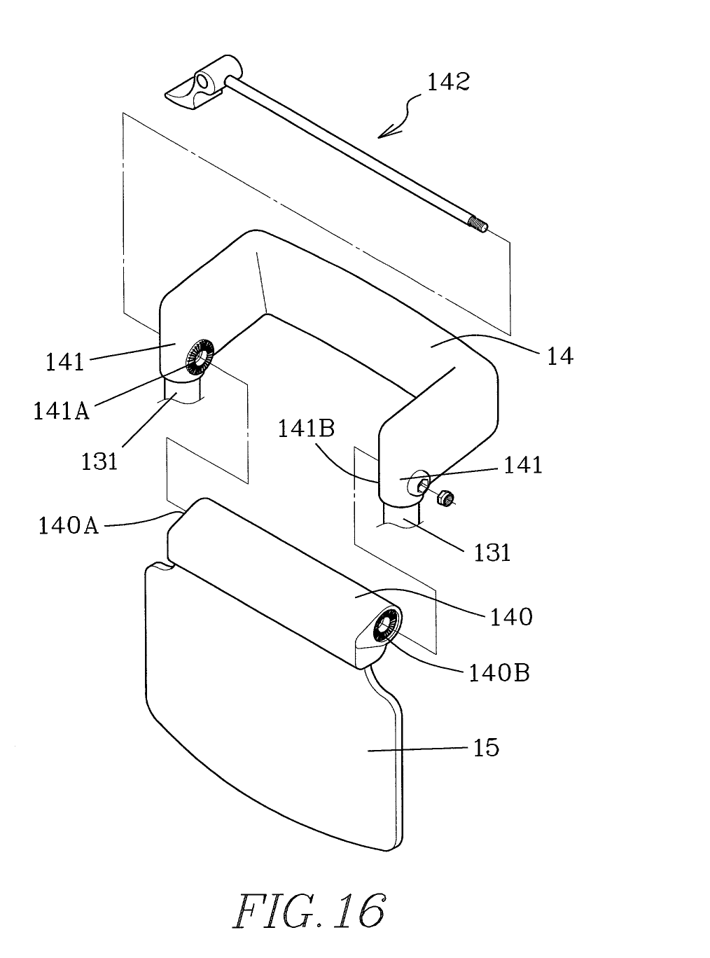

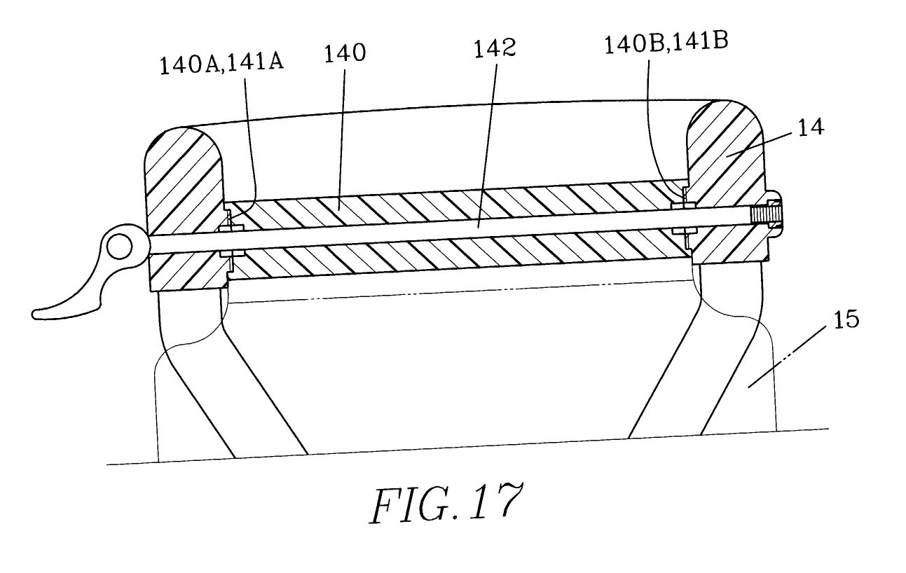

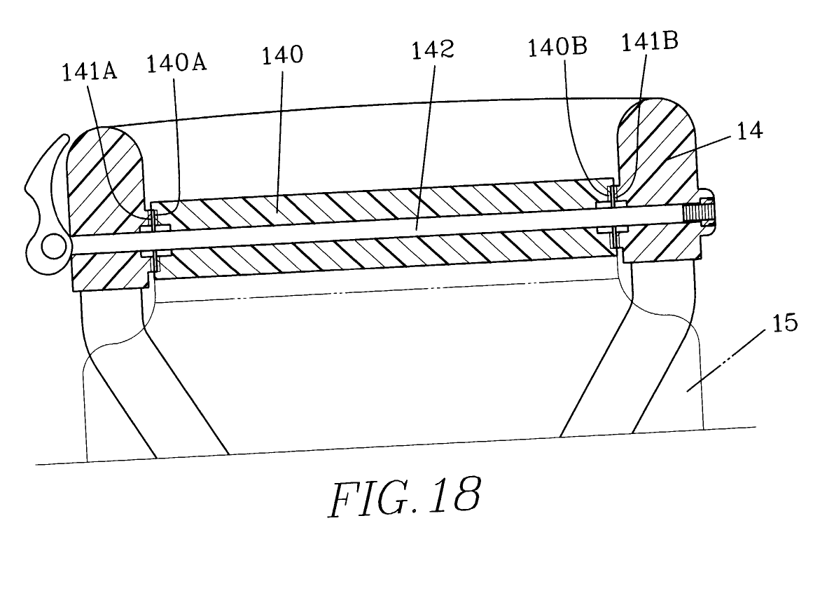

Next, as shown in FIGS. 16, 17 and 18, the score board 15 fixed on the handle 14 has the similar structure used in the folding unit 13, including a fix protruding base 140, two link bases 141 combined with two opposite lengthwise sides of the fix protruding base 140 and fixed on the handle 131. The two link bases 141 have respectively a flat toothed disc 141A and 141B and the fix protruding base 140 has two flat toothed discs 140A, 140B respectively formed on the two lengthwise opposite ends. Then the fix protruding base 140 and the two link bases 141 are combined together with a position element 142 structured just the same as that 133 of the folding unit 13. Therefore, the scoreboard 15 can be also adjusted in its angle. The configuration of the handle 14 and the score board 15 relates to the folding function of the cart frame, and the important point in the design involves arrangement of the collapsed golf cart in a package case after the wheels 22 are collapsed in wake of the collapsing of the handle 14 and the score board 15 so as to get a package case of a smallest size.

While the preferred embodiment of the invention has been described above, it will be recognized and understood that various modifications may be made therein and the appended claims are intended to cover all such modifications that may fall within the spirit and scope of the invention.

I claim:

1. A collapsing device for a golf cart comprising:
An upper rod provided with a lengthening unit:
A lower rod connected to a lower end of said upper rod, a collapsing unit provided between an upper end of said lower rod and said upper rod to enable said upper rod collapse to said lower rod: and,
Characterized by a folding unit provided on said upper rod, said folding unit permitting said upper rod to lengthen or shorten relative to said lower rod and to fold at the same time, thus said collapsing device enabling said golf cart collapsible to a size as small as possible for lowering cost for package and transporting.

2. The collapsing device for a golf cart as claimed in claim 1, wherein said folding unit consists of a fix protruding base fixed on said upper rod, a link base respectively combined with two lengthwise opposite sides of said fix protruding base, and a position element having an elongate rod extending in said fix protruding base and said two link bases and an eccentric push block fixed with one end of said elongate rod possible to adjust engagement or disengagement between said fix protruding base and said two link bases; said fix protruding base having a flat toothed disc respectively formed on the two lengthwise opposite sides, said two link bases respectively having a flat toothed disc engaging or disengaging from said flat toothed discs of said fix protruding base so that said folding unit may have function of adjusting its angle to suit to different body heights of users.

3. The collapsing device as claimed in claim 1, wherein a handle is further provided on the upper end of said upper rod, said handle provided on a score board with a fix protruding base combined with two link bases at its two sides, said link bases fixed on said handle, said protruding base and said two link bases engaging with or disengaging from each other by means of flat toothed discs provided on two sides of said fix protruding base and an inner side of said two link bases, and a position element extending in said fix protruding base and said two link bases for adjusting engagement or disengagement of said flat toothed discs of said fix protruding base and said two link bases to permit said score board adjust in its angle.
